(19) United States
(12) Patent Application Publication
(10) Pub. No.: US 2002/0180174 A1
(43) Pub. Date: Dec. 5, 2002

(54) Trailer assembly

(76) Inventor: Robert R. Johnston, Grosse Ile, MI (US)

Correspondence Address: David J. Simonelli, Clark Hill PLC, 500 Woodward Avenue, Detroit, MI, 48226-3435, US

(21) Appl. No.: 10/161,410

(22) Filed: May 31, 2002

Related U.S. Application Data
(60) Provisional application No. 60/295,304, filed on Jun. 1, 2001.

(51) Int. Cl. B60R 3/00

(52) U.S. Cl. 280/164.1

(57) ABSTRACT

A trailer assembly is used with a motor vehicle. The trailer assembly includes a frame that extends between a front end, which is selectively connectable to the motor vehicle, and a back end. The frame defines a frame plane extending therethrough. A fender is fixedly secured to the frame between the front and back ends. The fender extends through a curved path. The trailer assembly also includes a pad that is fixedly secured to the frame and the fender. The pad defines a top surface parallel to the frame plane. The pad allows an operator the ability to step on the pad to elevate himself to a location disposed adjacent the trailer assembly.

### BACKGROUND ART

1. Field of the Invention

The invention relates to trailers used to haul watercraft and the like behind a motor vehicle. More specifically, the invention relates to a trailer assembly that includes platforms for stepping onto the trailer.

2. Description of the Related Art

Trailers are used to increase the capacity of motor vehicles to haul cargo. Trailers are also used in conjunction with motor vehicles to haul oversized loads, such as watercraft. It is often difficult for those needing to secure the load or access the load (typically in the case when the load is a watercraft) because the volume of the load and the height of the load as it sits on a trailer make it difficult for one to reach above and/or over the load when needing to do so.

Those people working with the load oftentimes stand on the frame of the trailer to lift themselves to a workable height. Requiring a person to stand on the frame of the trailer leads to awkward, off-balance positions that do not facilitate the person's ability to perform well. The center of gravity of the person moves closer to the person if the person steps on the fender of the trailer. The fender, typically arcuate in construction, is not ideal for stepping because the person might slip off the curved fender, especially if it is wet.

An additional problem with trailer assemblies is that debris is thrown by the tires during the operation thereof. This is especially problematic when the trailer is a boat trailer because debris that is kicked up by the rotating tires may impact the watercraft being carried. Therefore, damage to the trailer and the cargo incurs when debris is kicked up.

### SUMMARY OF THE INVENTION

A trailer assembly is used with a motor vehicle. The trailer assembly includes a frame that extends between a front end, which is selectively connectable to the motor vehicle, and a back end. The frame defines a frame plane extending therethrough. A fender is fixedly secured to the frame between the front and back ends. The fender extends through a curved path. The trailer assembly also includes a pad that is fixedly secured to the frame and the fender. The pad defines a top surface parallel to the frame plane. The pad allows an operator the ability to step on the pad to elevate himself to a location disposed adjacent the trailer assembly.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a perspective view of a trailer assembly incorporating one embodiment of the invention;

FIG. 2 is a side view of a fender incorporating one embodiment of the invention;

FIG. 3 is a partially exploded perspective view of one embodiment of the invention;

FIG. 4 is a perspective view, partially cut away, of a fender incorporating a second embodiment of the invention;

FIG. 5 is a perspective view, partially cut away, of a fender attached to a trailer assembly, incorporating the first embodiment of the invention;

FIG. 6 is a side view of a second fender incorporating one embodiment of the invention;

FIG. 7 is a perspective view of the second fender attached to a trailer assembly, partially cut away, incorporating the first embodiment of the invention; and

FIG. 8 is a perspective view, partially cut away, of a fender attached to a trailer assembly, incorporating a second embodiment of the invention.

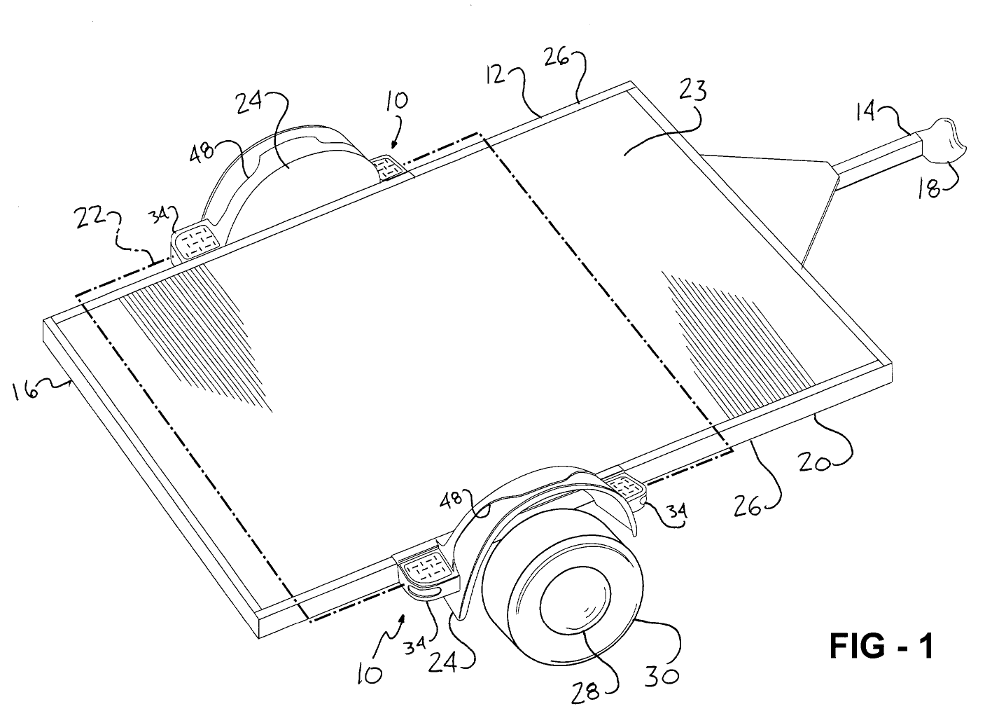

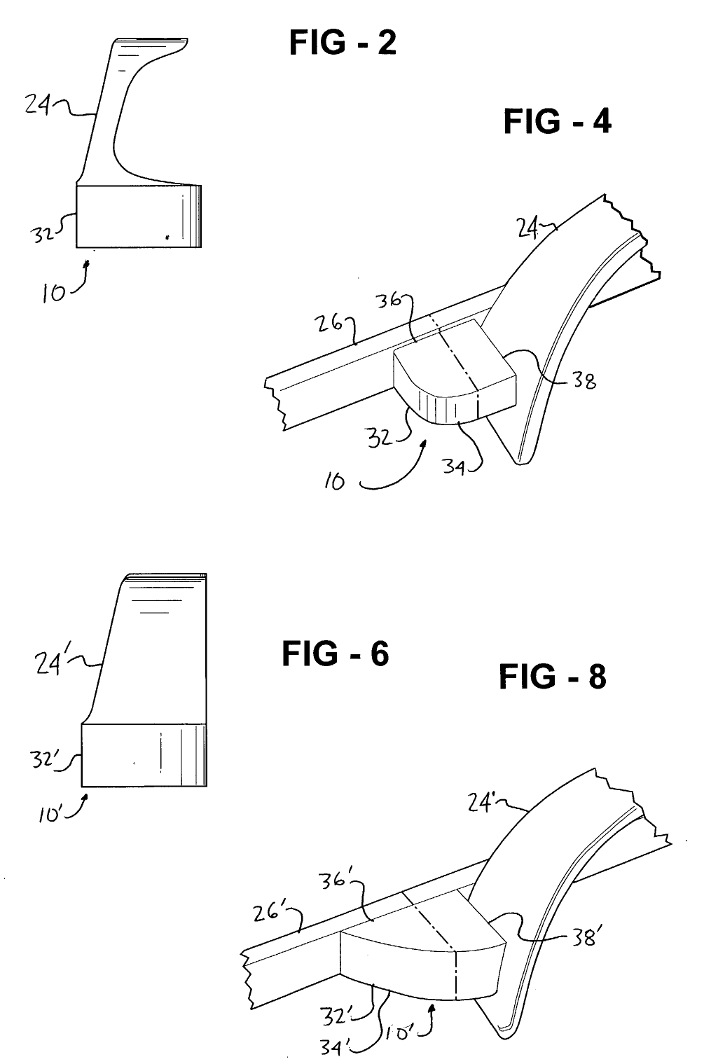

### DETAILED DESCRIPTION OF THE PREFERRED EMBODIMENT

Referring to the Figures, wherein like primed numerals represent similar elements in different embodiments, the invention is generally indicated at 10. The invention is a pad 10 for a trailer assembly, generally shown at 12. The trailer assembly 12 extends between a front end 14 and a back end 16. The front end 14 includes a hitch receptacle 18 that will receive a ball or like coupler on a hitch of a motor vehicle (neither shown).

The trailer assembly 12 defines a frame 20 that extends between the front 14 and back 16 ends. The frame 20 defines a frame plane 22 that is generally parallel to ground during normal operation. It should be appreciated by those skilled in the art that the frame 20 may be oriented such that the frame plane 22 is not parallel to the plane parallel to ground. A cargo space 23 extends above the frame 20. This is where much, if not all, of the cargo (not shown) is stored on the trailer assembly 12 when the trailer assembly 12 is used. It should be appreciated that while the trailer assembly 12 is shown as a flat bed trailer, it should be appreciated by those skilled in the art that other types of trailers, i.e., boat trailers, may be used with the invention.

The trailer 12 includes a pair of fenders 24. The fenders 24 are fixedly secured to sides 26 of the frame 20 and cover the wheels 28 and tires 30 that are secured to the trailer 12. The fenders 24 extend through a curved path. More specifically, the fenders 24 are arcuate in construction. The fenders 24 are secured to the sides 26 between the front end 14 and the back end 16. Typically, the fenders 24 and the wheels 28 are closer to the back end 16 of the trailer assembly 12.

The pads 10 are fixedly secured to the frame 20 and the fenders 24. The pads 10 extend between the frame 20 and the fenders 24. Depending on the trailer assembly 12, there may be two to four pads 10. If there are four pads 10, each fender 24 has two pads 10 abutting thereagainst, whereas if there are only two pads 10, the pads 10 may be in front or behind the fenders 24. The pads 10 help increase the life of the trailer assembly 12 by stopping rocks and other road debris from hitting the trailer assembly 12 while in use. In other words, the pads 10 deflect debris that is thrown up by the tires 30 during operation thereof.

Each of the pads includes a support body 32. The support body 32 is a tubular structure including an arcuate side 34, a frame side 36 and a fender side 38. The arcuate side 34 extends between the frame 36 and fender 38 sides to form the support body 32 with three sides. It should be appreciated by those skilled in the art that the arcuate side 34 may be replaced with two straight sides without adding an inventive element to the invention.

The frame side 36 of each of the pads 10 is fixedly secured to the side 26 of the frame 20. Likewise, the fender side 38 of each of the pads 10 is fixedly secured to one of the fenders 24. Any suitable means for securing the sides 36, 38 to the frame 20 and fender 24 may be used. A non-exhaustive list of means for securing the sides 36, 38 to the frame 20 and fenders 24 include, but are not limited to, bolting, bonding, welding and the like.

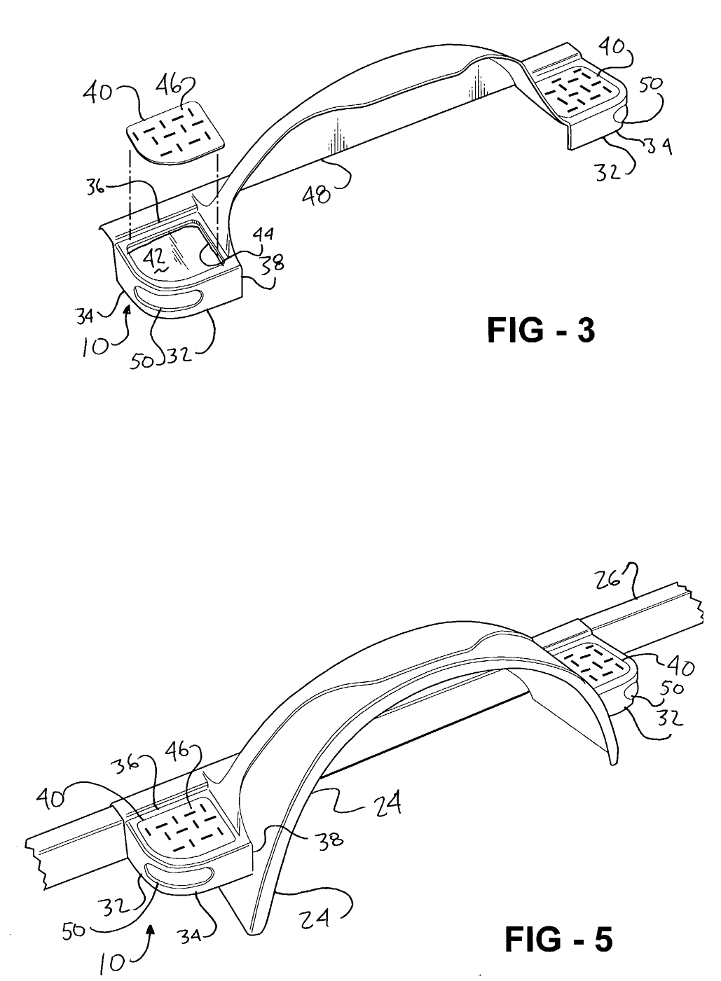

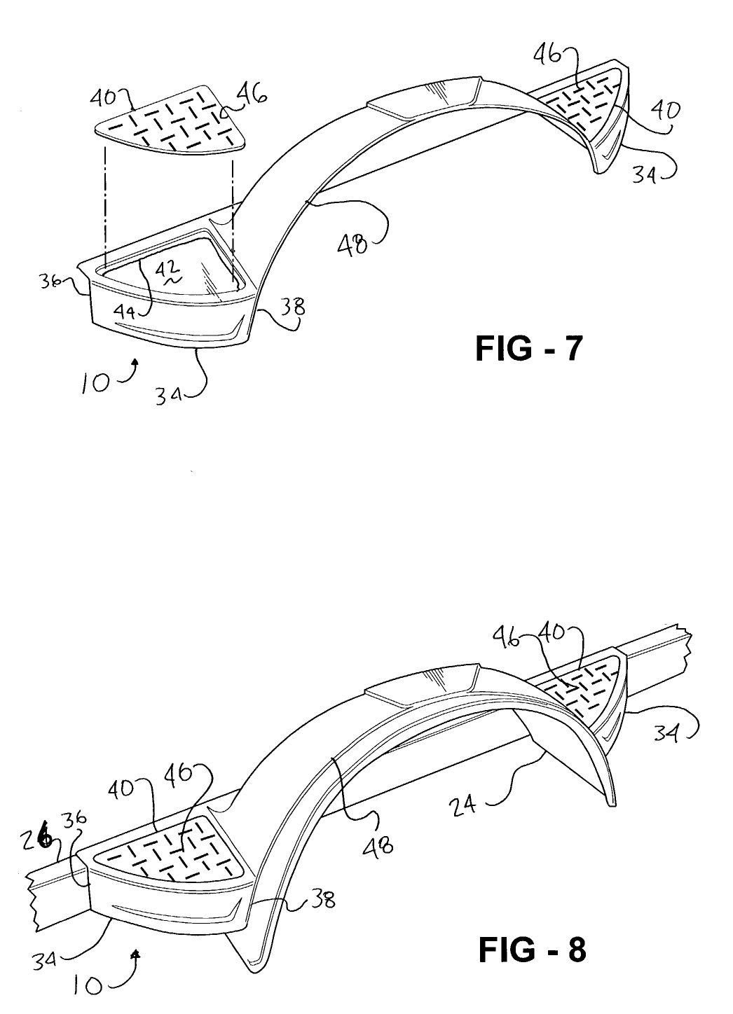

Each of the pads 10 further includes a cap 40. The cap 40 defines a top surface that covers a space 42 between the sides 34, 36, 38 of the pads 10. In the embodiment shown in FIGS. 3 and 7, the cap 40 is supported by a lip 44 extending around a periphery defined by the sides 34, 36, 38. In alternative embodiments, the cap 40 may include a flange or flanges extending around its periphery to fit over one or more of the sides 34, 36, 38.

The cap 40 includes a non-slip top surface 46. This will provide needed support and stability for a person requiring to elevate himself with respect to the trailer assembly 12 to do so by stepping on the cap 40 with less concern for wet or slippery surface conditions.

In one embodiment, a pad 10 is used on either side of the fender 24. A decorative trim piece 48 extends over the fender 24 between the two pads 10. The pads 10 and the trim piece 48 are a unitary structure. This aids in the manufacturing of the trailer assembly 12.

In the first embodiment of the invention, the arcuate side 34 includes a port 50 through which a light may extend. The port 50 would allow for additional or decorative lighting. The wire harness and light bulb are housed within the space 42 of the pads 10.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

I claim:

1. A trailer assembly for use with a motor vehicle, said trailer assembly comprising:
a frame extending between a front end selectively connectable to the motor vehicle and a back end, said frame defining a frame plane extending therethrough;
a fender fixedly secured to said frame between said front and back ends and extending through a curved path; and
a pad fixedly secured to said frame and said fender, said pad defining a top surface parallel to said frame plane such that an operator may step on said pad for elevation at a location disposed adjacent said trailer assembly.

2. A trailer assembly as set forth in claim 1 wherein said pad includes a support body.

3. A trailer assembly as set forth in claim 2 wherein said support body is tubular in shape such that said support body defines a space.

4. A trailer assembly as set forth in claim 3 wherein said support body includes an arcuate side.

5. A trailer assembly as set forth in claim 4 wherein said support body further includes a fender side and a frame side configured such that said arcuate side extends between said fender and frame sides.

6. A trailer assembly as set forth in claim 5 wherein said pad includes a cap extending between said arcuate, fender and frame sides to cover said space.

7. A trailer assembly as set forth in claim 6 wherein said cap includes a non-slip top surface.

8. A trailer assembly as set forth in claim 7 wherein said arcuate side includes a port for providing access to said space.

9. A trailer assembly for use with a motor vehicle, said trailer assembly comprising:
a frame extending between a front end selectively connectable to the motor vehicle and a back end, said frame defining a frame plane extending therethrough;
a fender fixedly secured to said frame between said front and back ends and extending through a curved path;
a first pad fixedly secured to said frame and said fender, said first pad defining a top surface parallel to said frame plane such that an operator may step on said first pad for elevation at a location disposed adjacent said trailer assembly;
a second pad fixedly secured to said frame and said fender, said second pad defining a second top surface parallel to said frame plane such that an operator may step on said second pad for elevation at a location disposed adjacent said trailer assembly; and
a trim piece extending between said first and second pads connecting said first pad to said second pad.

10. A trailer assembly as set forth in claim 9 wherein said trim piece extends over said fender.
